(19) United States
(12) Patent Application Publication
(10) Pub. No.: US 2015/0149327 A1
(43) Pub. Date: May 28, 2015

(54) INTEGRATED CONTENT PROVIDER-DISTRIBUTOR NETWORK

(71) Applicant: LIVE365, INC., Foster City, CA (US)

(72) Inventors: Nikita Fonarev, Novato, CA (US); Kevin Liao, Foster City, CA (US)

(73) Assignee: LIVE365, INC., Foster City, CA (US)

(21) Appl. No.: 14/611,107

(22) Filed: Jan. 30, 2015

Related U.S. Application Data
(63) Continuation-in-part of application No. 14/194,418, filed on Feb. 28, 2014.
(60) Provisional application No. 61/933,757, filed on Jan. 30, 2014.
(60) Provisional application No. 61/775,583, filed on Mar. 9, 2013.

(51) Int. Cl. H04L 29/06; G06Q 30/06; G06F 3/0482

(52) U.S. Cl. CPC H04L 65/403; G06F 3/0482; G06Q 30/0641
USPC 705/27.1; 715/716

(57) ABSTRACT

An graphical user interface for providing a digital platform including interactive tools to a plurality of content providers to enable broadcasting via digital streaming by the content providers, side-loading and cross selling between content providers, connecting one or more content providers with each other and with selected content consumers is disclosed.

### CROSS REFERENCE TO RELATED APPLICATIONS

This application claims the benefit of U.S. Provisional Patent Application No. 61/933,757 filed Jan. 30, 2014, entitled, “Integrated Content Provider-Distributor Network,” by Fonarev et al., and U.S. patent application Ser. No. 14/194,418 filed Feb. 28, 2014, entitled, “Integrated Content Provider-Distributor Network,” by Fonarev et al., which in turn claims priority to U.S. Provisional Patent Application No. 61/775,583 filed Mar. 9, 2013, entitled, “Integrated Content Provider-Distributor Network,” by Fonarev et al., and all of which are hereby incorporated by reference in their entirety.

### NOTICE REGARDING COLOR DRAWINGS

The patent or application file contains at least one drawing executed in color. Copies of this patent or patent application publication with color drawing(s) will be provided by the Office upon request and payment of the necessary fee.

### TECHNICAL FIELD

The present invention is directed to electronic communications, and more specifically to aspects of digital media content acquisition, curation, creation, promotion, distribution, and delivery technology.

### BRIEF DESCRIPTION OF THE DRAWINGS

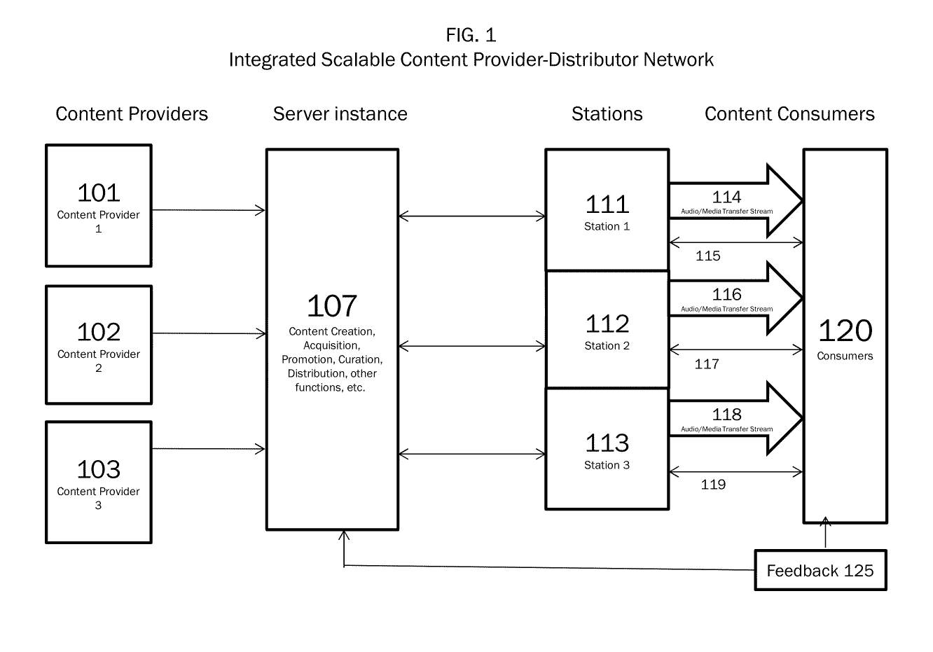

FIG. 1 is a high-level diagram showing aspects of a discrete content provider-distributor network, according to certain embodiments.

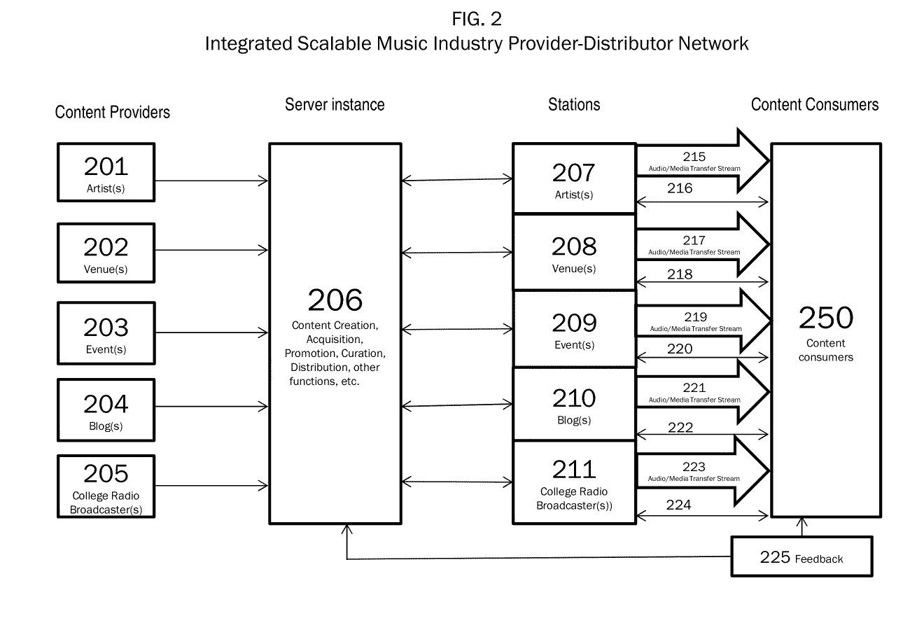

FIG. 2 is a high-level diagram showing aspects of a discrete content provider-distributor network in the music industry, according to certain embodiments.

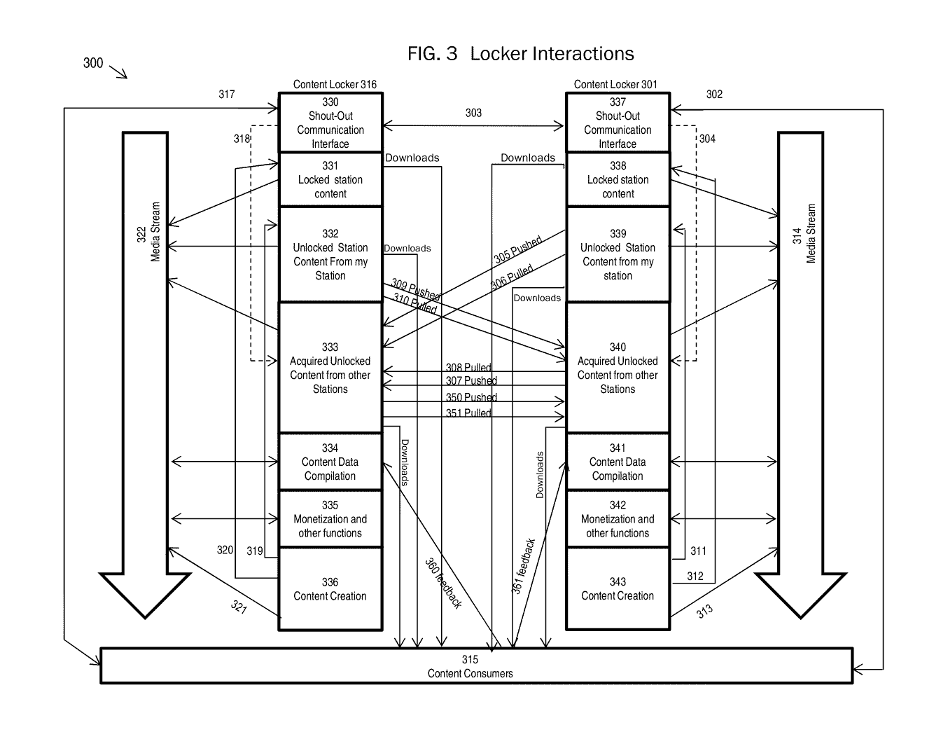

FIG. 3 is high-level drawing that illustrates the interactivity between stations using certain embodiments of the computer-implemented platform.

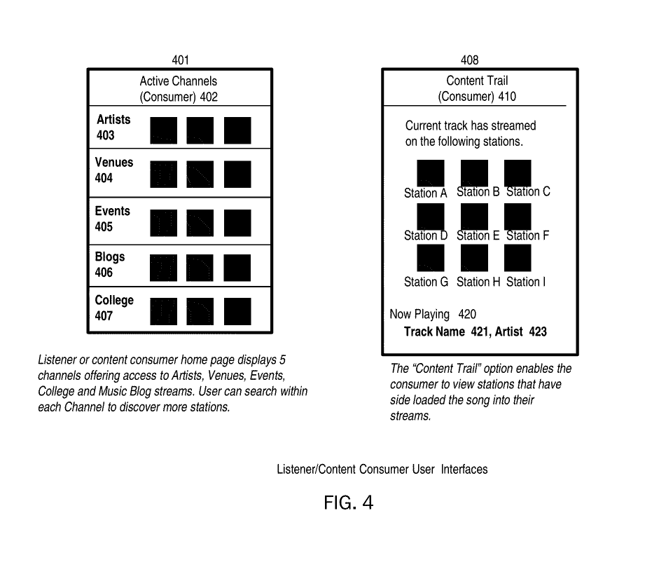

FIG. 4 illustrates sample content consumer interfaces associated with the locker application and the computer-implemented platform, according to certain embodiments.

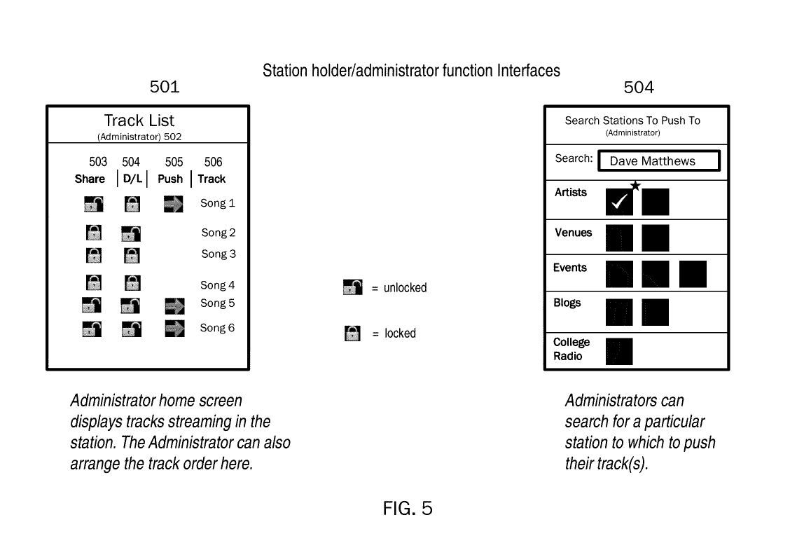

FIG. 5 illustrates sample station holder interfaces associated with the locker application and the computer-implemented platform, according to certain embodiments.

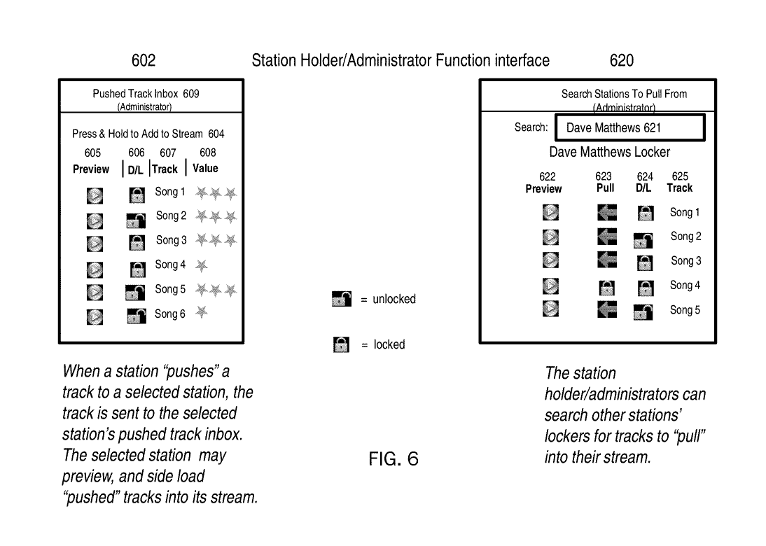

FIG. 6 illustrates more sample station holder interfaces associated with the locker application and the computer-implemented platform, according to certain embodiments.

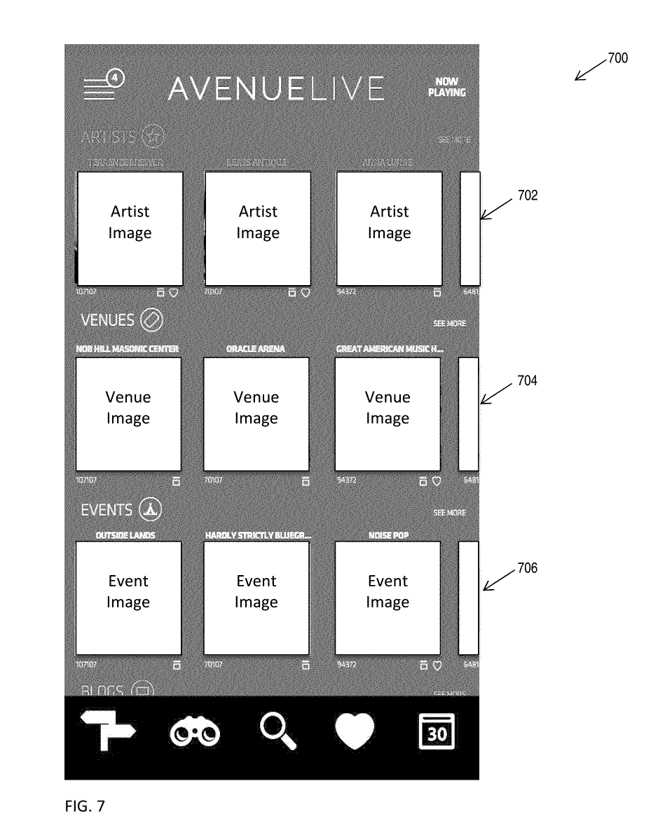

FIG. 7 illustrates a home screen graphical user interface, according to certain embodiments.

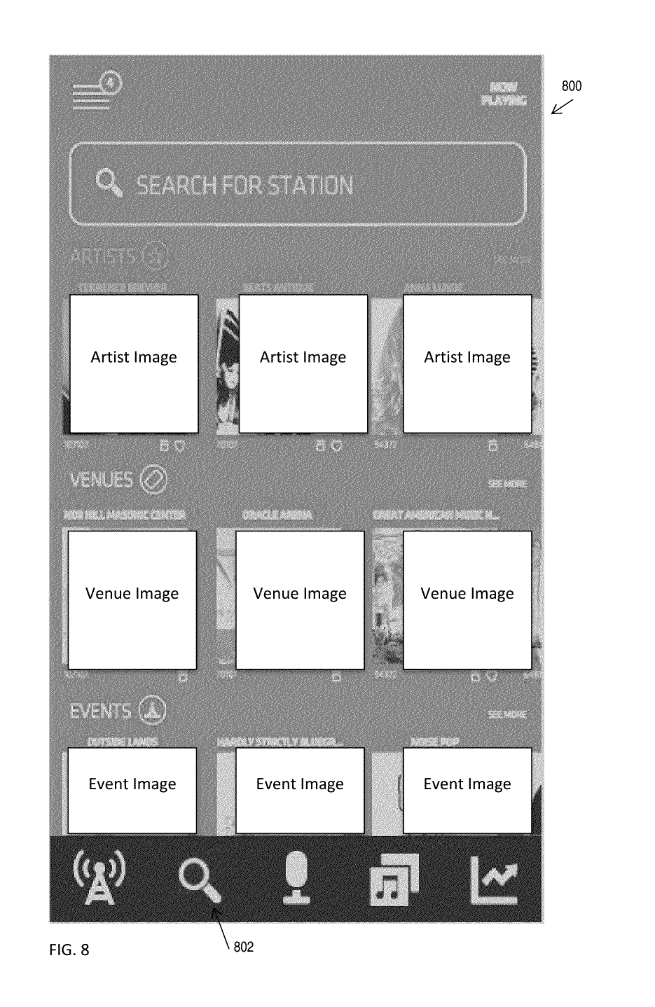

FIG. 8 illustrates a listener search screen graphical user interface, according to certain embodiments.

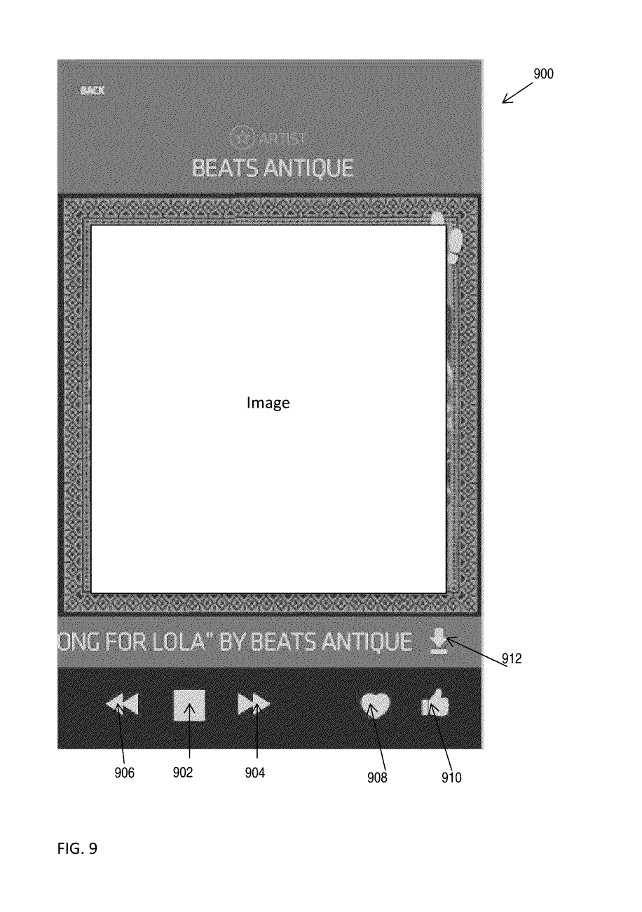

FIG. 9 illustrates a “now playing” screen graphical user interface, according to certain embodiments.

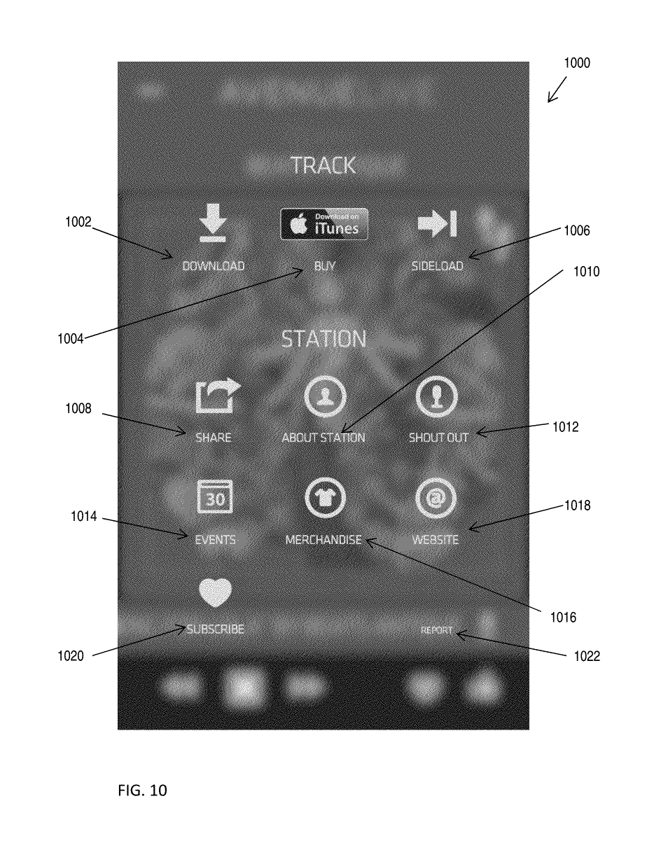

FIG. 10 illustrates an options and listener marketplace screen graphical user interface, according to certain embodiments.

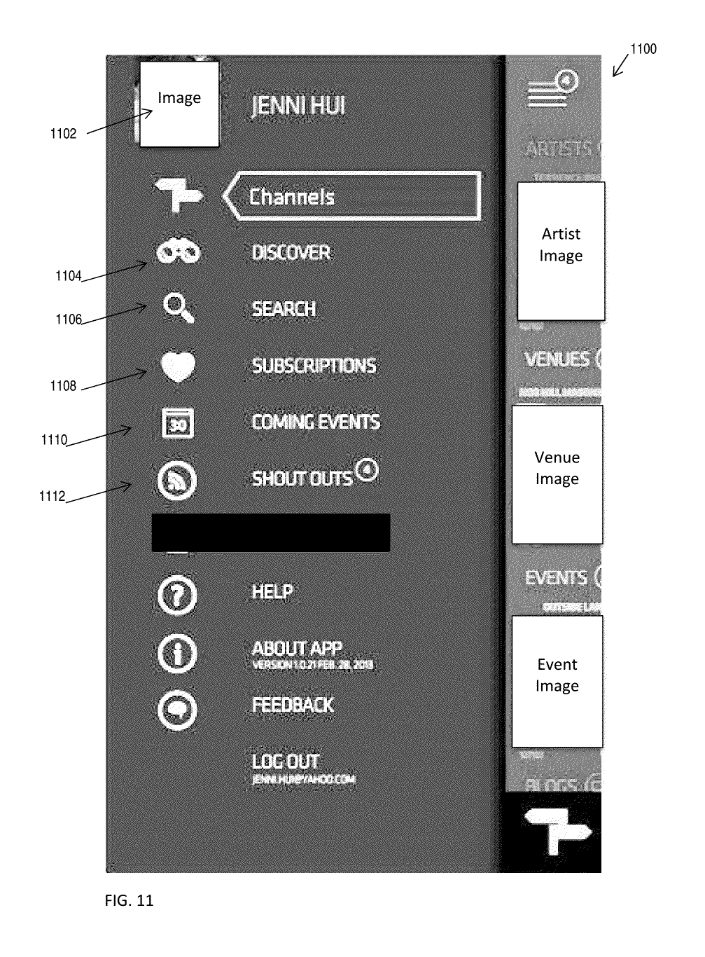

FIG. 11 illustrates a listener menu options screen graphical user interface, according to certain embodiments.

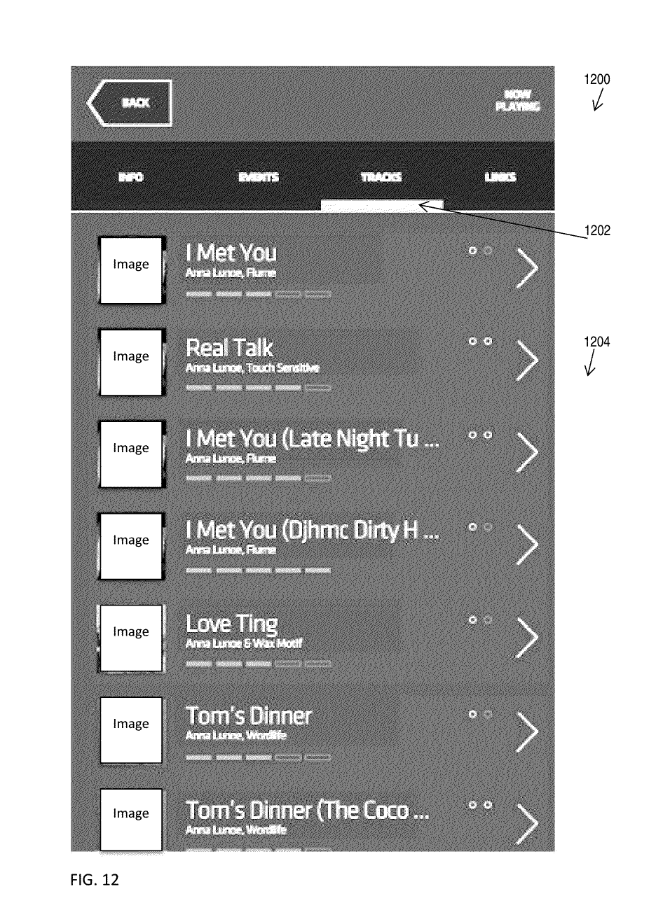

FIG. 12 illustrates a station tracks list screen graphical user interface, according to certain embodiments.

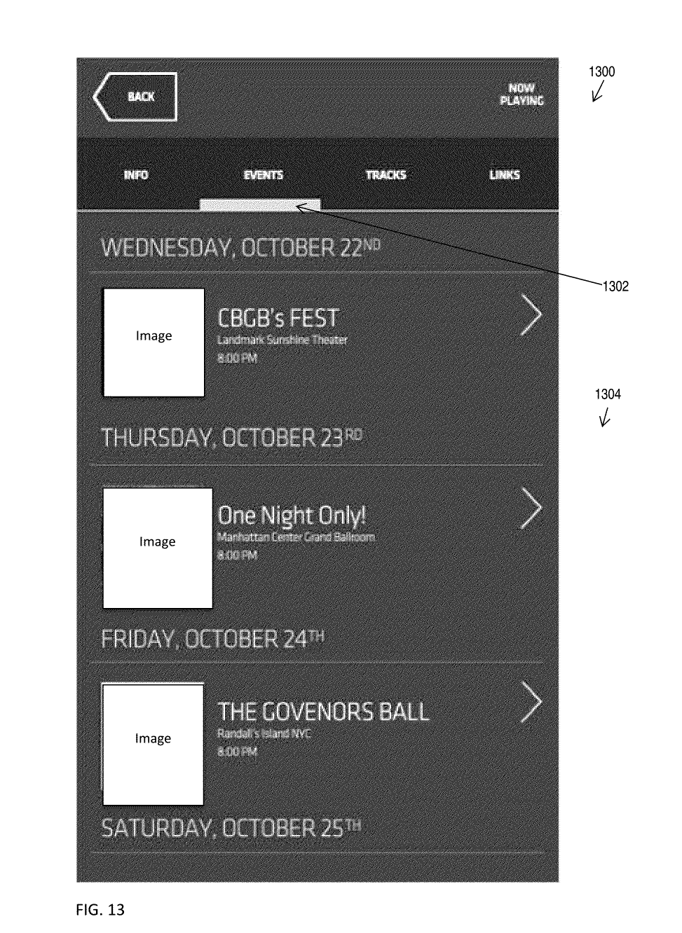

FIG. 13 illustrates a station events list screen graphical user interface, according to certain embodiments.

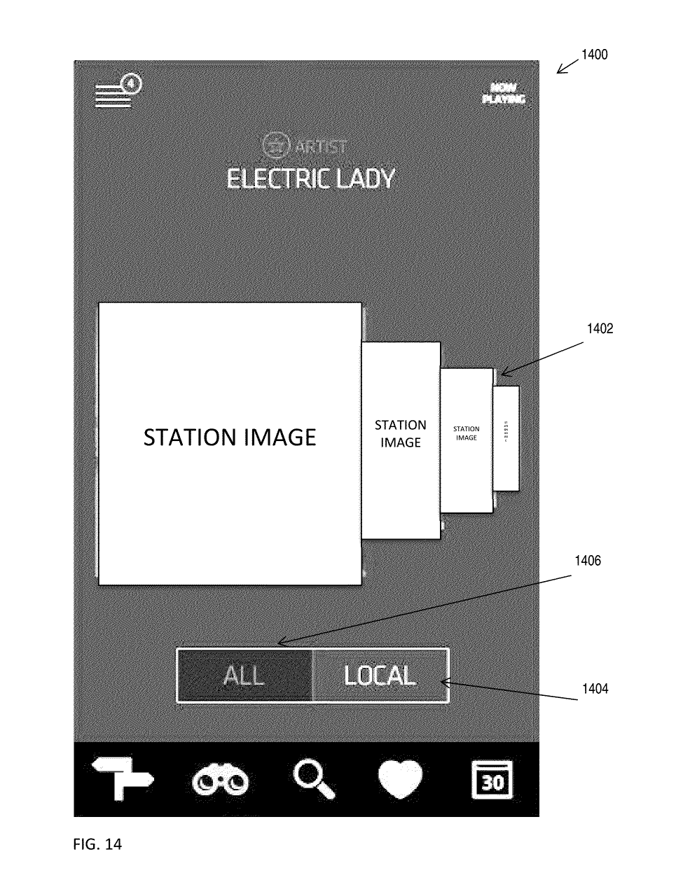

FIG. 14 illustrates a discover mode screen graphical user interface, according to certain embodiments.

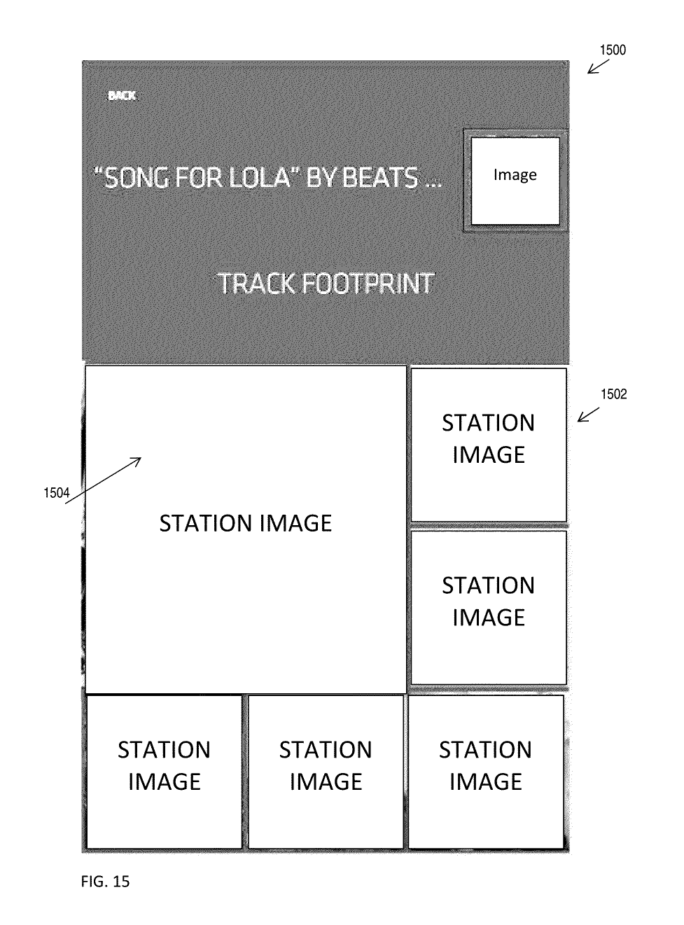

FIG. 15 illustrates a track footprint screen graphical user interface, according to certain embodiments.

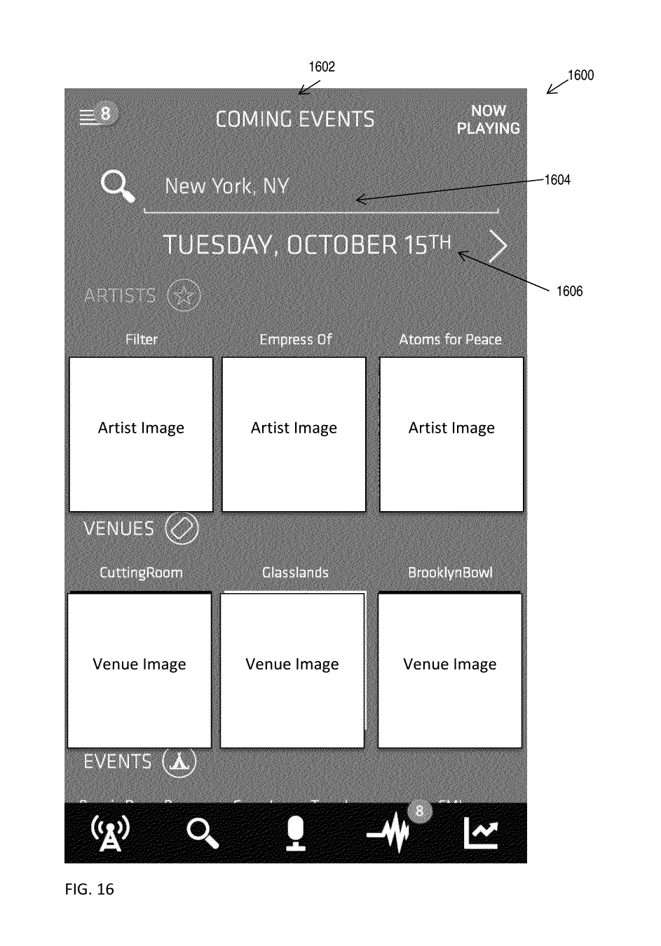

FIG. 16 illustrates a coming events screen graphical user interface, according to certain embodiments.

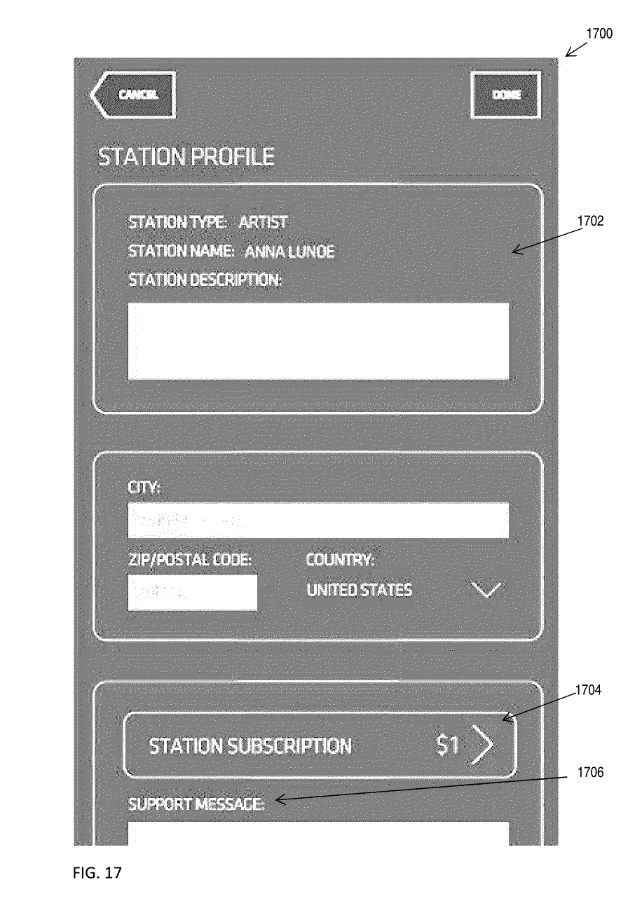

FIG. 17 illustrates a station holder profile setup screen graphical user interface, according to certain embodiments.

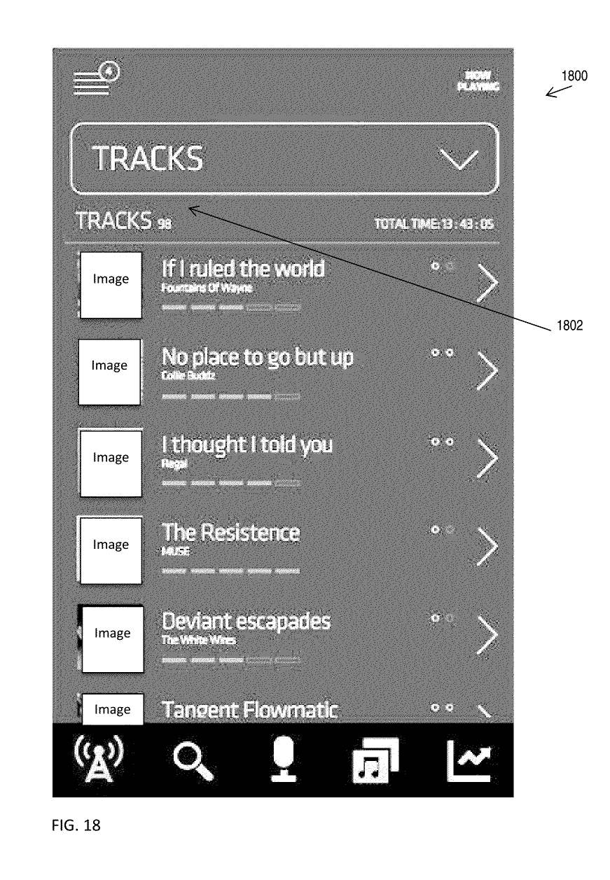

FIG. 18 illustrates a station holder admin screen graphical user interface, according to certain embodiments.

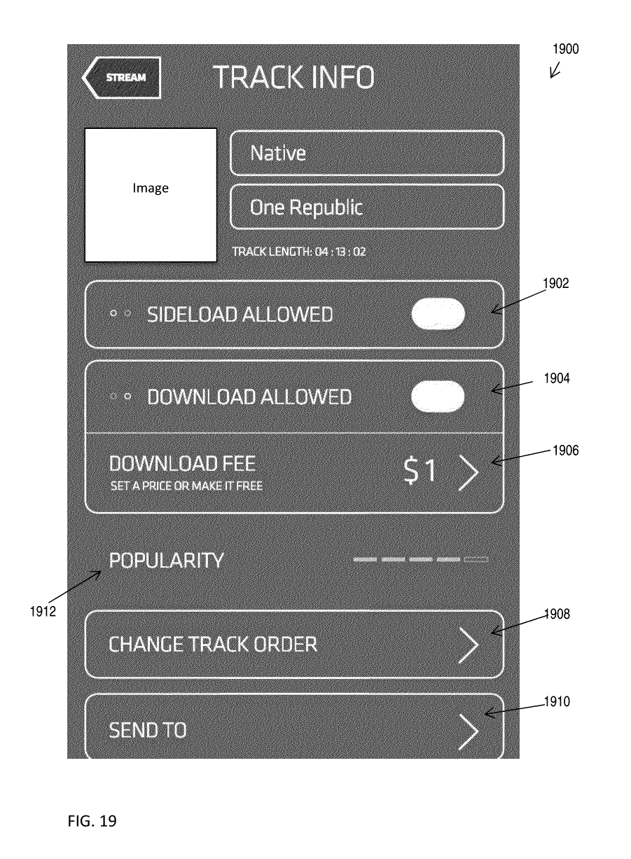

FIG. 19 illustrates a track controls screen graphical user interface, according to certain embodiments.

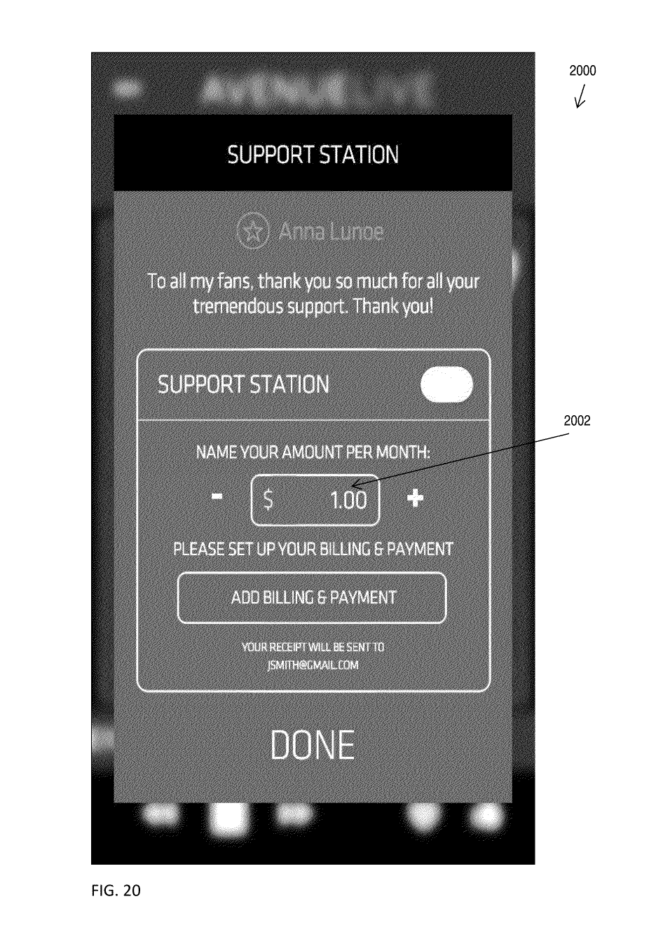

FIG. 20 illustrates a station subscription screen graphical user interface, according to certain embodiments.

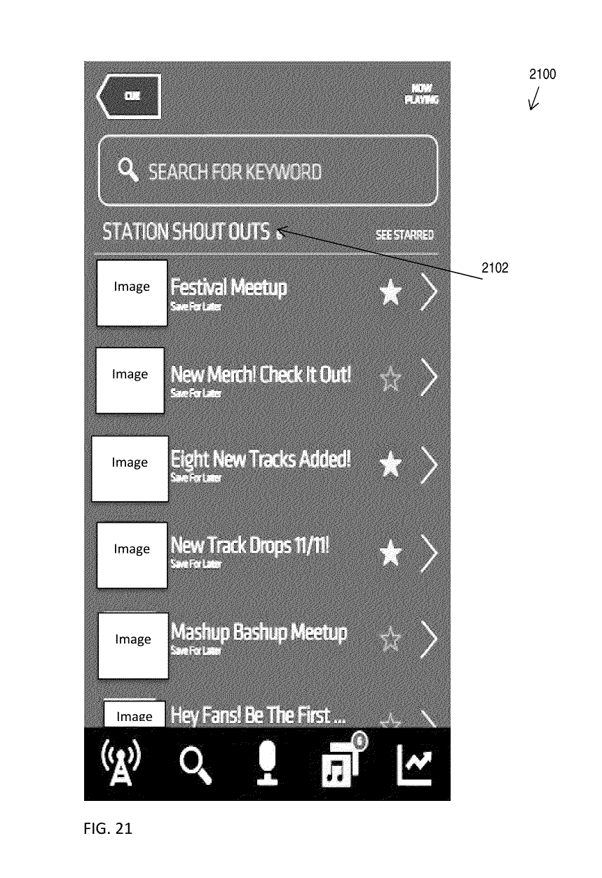

FIG. 21 illustrates a shout out inbox screen graphical user interface, according to certain embodiments.

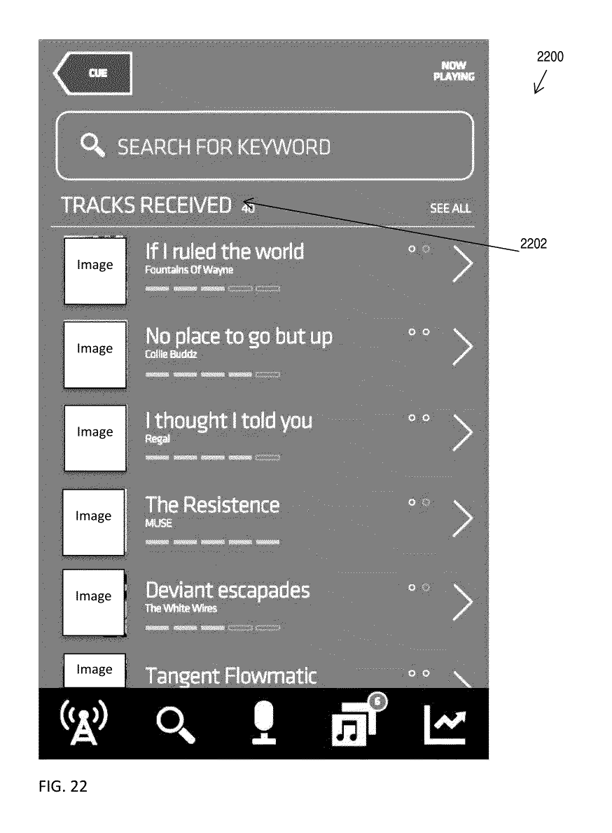

FIG. 22 illustrates a tracks received inbox screen graphical user interface, according to certain embodiments.

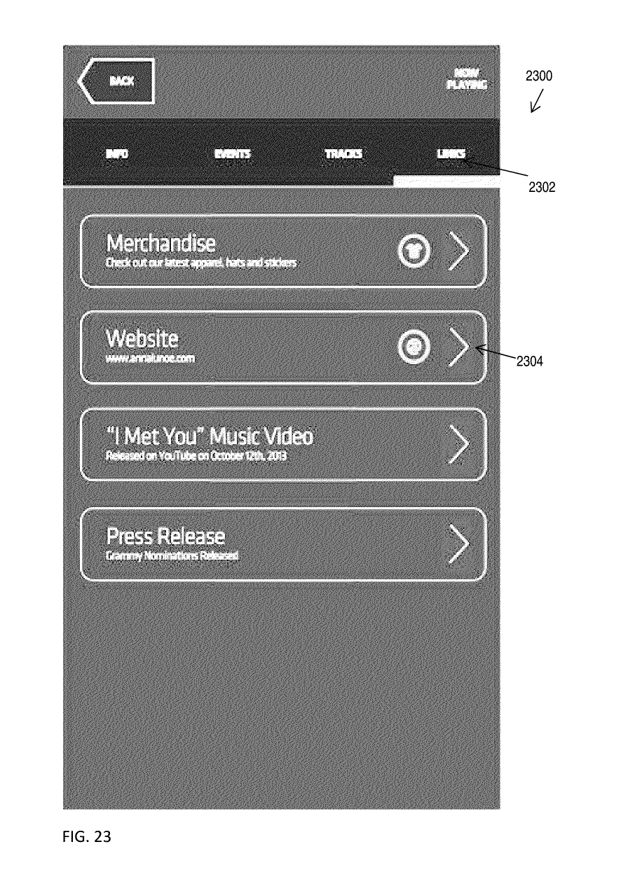

FIG. 23 illustrates a station links list screen graphical user interface, according to certain embodiments.

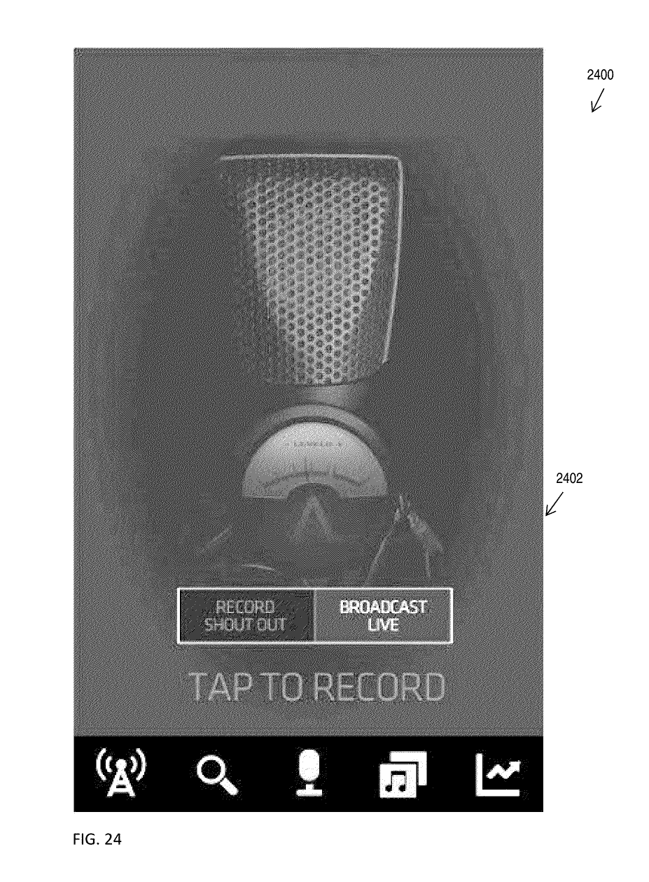

FIG. 24 illustrates a shout out screen graphical user interface, according to certain embodiments.

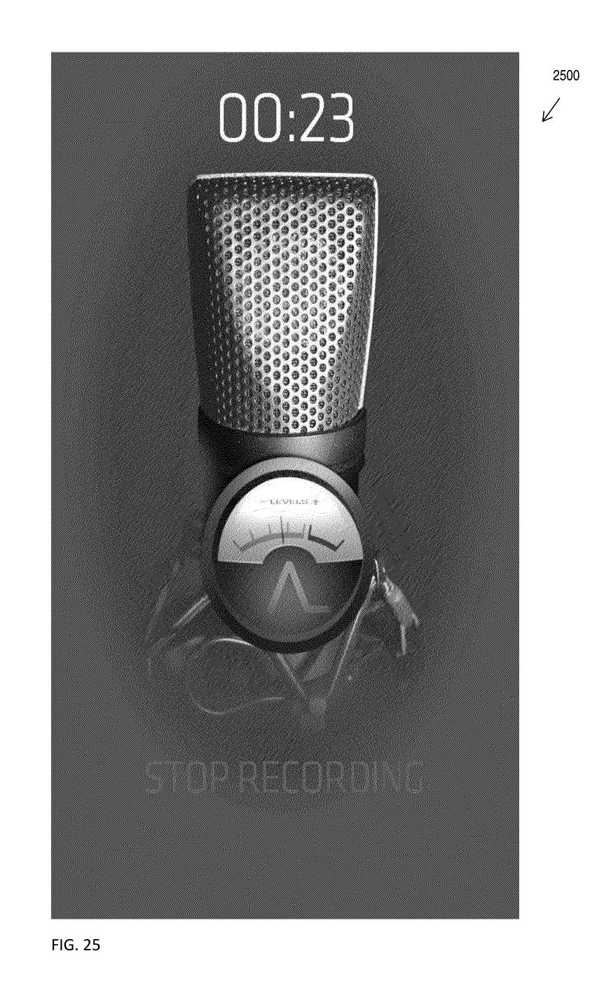

FIG. 25 illustrates a shout out recording screen graphical user interface, according to certain embodiments.

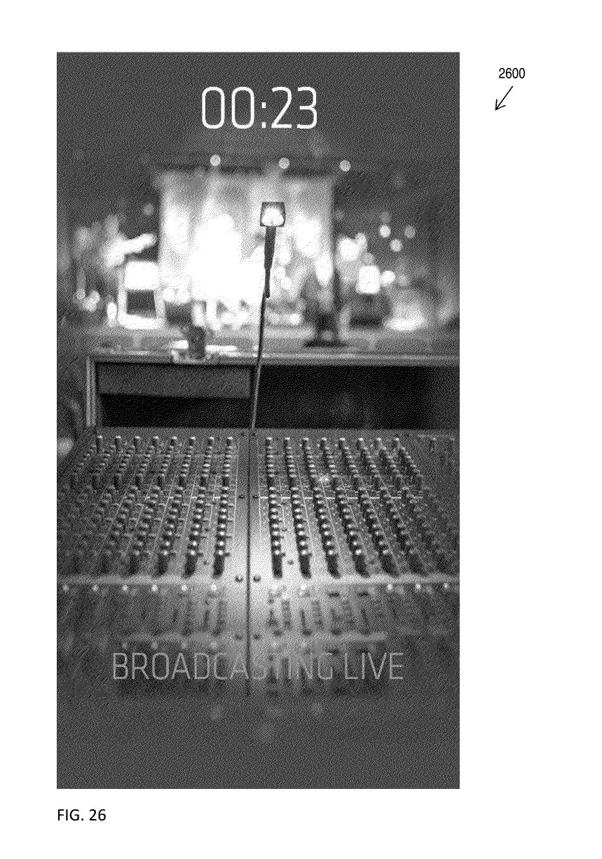

FIG. 26 illustrates a broadcast live screen graphical user interface, according to certain embodiments.

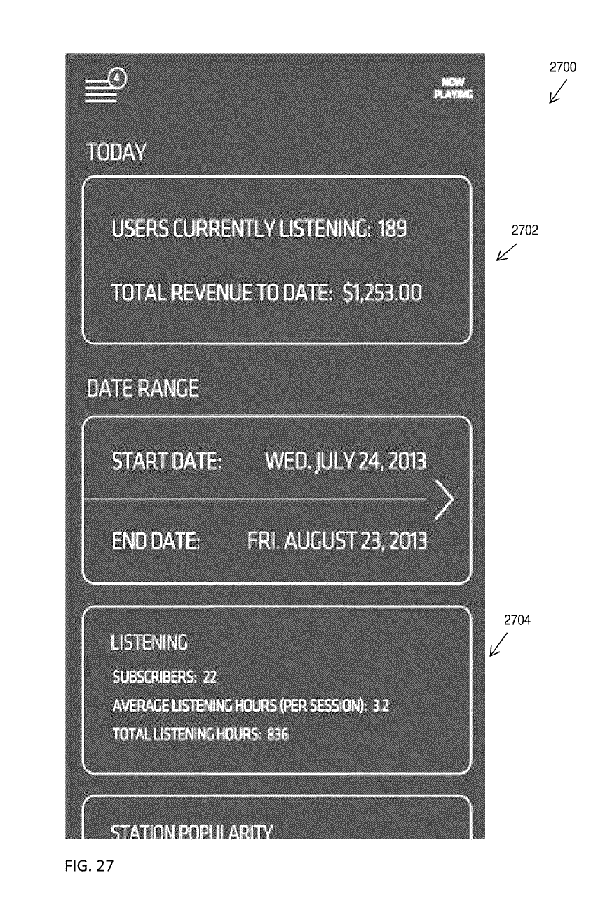

FIG. 27 illustrates an analytics screen graphical user interface, according to certain embodiments.

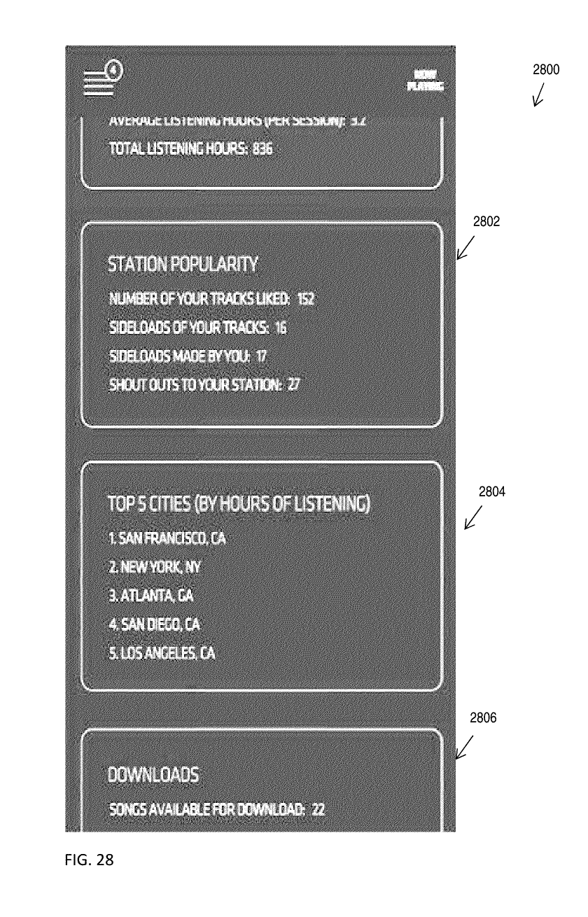

FIG. 28 illustrates a continuation of the analytics screen of FIG. 27, according to certain embodiments.

### DETAILED DESCRIPTION

Methods, systems, user interfaces, and other aspects of the invention are described. Reference will be made to certain embodiments of the invention, examples of which are illustrated in the accompanying drawings. While the invention will be described in conjunction with the embodiments, it will be understood that it is not intended to limit the invention to these particular embodiments alone. On the contrary, the invention is intended to cover alternatives, modifications and equivalents that are within the spirit and scope of the invention. The specification and drawings are, accordingly, to be regarded in an illustrative rather than a restrictive sense.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks that are well known to those of ordinary skill in the art are not described in detail to avoid obscuring aspects of the present invention.

According to certain embodiments, a computer implemented platform is created to support and enhance networking relationships in any multimedia communications industry involving a discrete content provider-distributor network or networks. A “discrete content provider-distributor network” is any system of connections involving one or more parties that may at times provide multimedia content and/or may at times distribute such multimedia content to consumers. The invention integrates a discrete content provider-distributor network by bringing together separate parties in the form of a community and allowing more efficient, more direct, more widespread, and more enhanced connections, communications, interactions, and transactions by and among them.

The multimedia communications industry as referenced herein includes but is not limited to the music industry and its associated discrete networks of multimedia content providers, distributors, and consumers.

According to certain embodiments, such a computer-implemented platform may be a digital platform that includes one or more computer networks such as internets, intranets, extranets or some combination thereof. Such a digital platform may be cloud-based. According to certain other embodiments, the computer implemented platform may be operated within a private network. The network may be a distributed network.

Such a computer-implemented platform also includes software applications, computer servers, computer databases, storage devices, and user interfaces to allow the relevant players in the multimedia communications industry to: 1) network, 2) promote products and services, 3) monetize products and services, 4) engage with each other, 5) engage with each other's followers and/or fans, and 6) broadcast streaming multimedia content (including but not limited to content consumer listening/watching to streaming audio/media content and downloading such content).

According to certain embodiments, categories of users of the digital platform described herein include but are not limited to: 1) artists, 2) venues (including but not limited to owners and managers of such venues), 3) events (including but not limited to promoters, organizers and creators of such events), 4) bloggers, and 5) college radio broadcasters. User categories are herein referred to as user “channels.”

As a non-limiting example, the channels that form a discrete music industry content provider-distributor network include artists, venues, events, bloggers and college radio broadcasters. Artists are the creators of original content (multimedia or single media) that can be distributed, such as through a network. Venue owners manage physical establishments that allow artists to showcase the artist's work (music, music videos etc.) to audiences, followers, and fans. Event promoters or entertainment promoters market and create interest in live events such as concerts, festivals, etc. For example, event promoters work with venues to organize events that range from small parties in local venues to multi-day festivals in big open spaces. Bloggers write artist reviews to showcase artists, artist's work, music bands, DJs, sound tracks, music videos, etc. College radio broadcasters are stations that are useful for discovery of primarily up-and-coming artists and “indie” bands (i.e., independent music or bands that are generally not affiliated with a major record label). Thus, college radio broadcaster stations generally tend to provide a distribution system for new artists.

According to certain embodiments, each of the aforementioned categories of users, or channels, can use the computer-implemented platform described herein to create one or more “stations” to broadcast streaming multimedia or single media content to consumers.

According to certain embodiments, multimedia content can include sound, or image, or animation, or video, or text, or graphics, or any combination thereof. Thus, the embodiments include the use of single media content such as only audio, or only video or only text, or only graphics or only image. Further, at least a subset of stations or channels is not restricted to broadcasting only one particular form of content. For example, a particular station may broadcast multimedia content some of the time and may broadcast single media content at other times. For convenience, the term “content” as used herein can mean multimedia content or single media content.

A station can integrate and program for broadcasting its own content or content created by other stations, depending on the access rights attached to the content as described in greater detail with reference to FIGS. 1-6.

According to certain embodiments, each of the aforementioned categories of users can use the computer-implemented platform described herein for 1) creating broadcasting stations, 2) curating multimedia content, 3) searching multimedia content, 4) creating multimedia content, 5) promoting multimedia content, 6) acquiring multimedia content, 7) distributing multimedia content amongst broadcasting stations, 8) discovering multimedia content, 9) streaming multimedia content to consumers, 10) interacting amongst broadcasting stations and consumers, and 11) monetizing multi or single-media streams. The categories of users can also use the platform to monetize products and services.

According to certain embodiments, each “station” is associated with a computer-implemented content “locker” that is described in greater detail with reference to FIG. 3. The content locker allows a station to perform the functions mentioned above (curating, searching, creating, distributing, discovering, etc.) through a user interface/application interface by using a mobile device or a computer (client devices).

FIG. 1 is a high-level diagram showing aspects of a discrete content provider-distributor network, according to certain embodiments. FIG. 1 shows three content providers (101, 102, 103). The embodiments are not limited to the number of content providers shown in FIG. 1. For example, a set of content providers can include all or any of the categories of users of the computer-implemented platform including but not limited to the aforementioned music industry content provider-distributor network: 1) artists, 2) venues, 3) events, 4) bloggers, and 5) college radio broadcasters. Further, there may be multiple content providers from a given user category (“channel”). For example, while only one content provider 1 101 is shown, there may be a plurality of content promoters of the same category as content provider 1. Similarly, there may be a plurality of content providers in the same categories as content provider 2 102 and content provider 3 103 etc.

FIG. 1 also shows a server instance 107, and stations (111, 112, 113) such as content station 1 111, content station 2 112, and content station 3 113. While only 3 stations are shown, there may be many more stations because the number of stations corresponds to the number of content providers from any of the user categories or channels mentioned above. Further, it is to be understood that there may be multiple server instances that are associated with one or more servers in the computer-implemented platform of the embodiments. Each station uses server instance 107 to create content streams (114, 116, 118) for streaming and/or transferring content to content consumers 120. Stations (111, 112, 113) can also use server instance 107 to perform one or more of the following functions: 1) curate content, 2) search content, 3) create content, 4) promote content, 5) acquire content, 6) distribute content amongst broadcasting stations, 7) discover content, 8) allow consumers to download content, and 9) monetize products and services. Content consumers 120 may provide feedback information 125. Further, stations may create customized messages with any content (audio or video or image or graphics or text, either alone or any combination thereof) desired by the station, known as a “broadcaster message.” A broadcaster message may then be sent to server instance for processing and thereby inserted directly into content streams (114, 116, 118) for instantaneous, near-instantaneous, or other time interval communication of the broadcaster message to one or more content consumers. Similarly, content consumers can create “consumer messages” such as messages (115, 117, 119) for sending to the stations. Consumer messages can be customized messages with any content (audio or video or image or graphics or text, either alone or any combination thereof). The initial message is also referred to as a “shout out” and a reply message is also referred to as a “shout back.”

Such broadcaster messages and consumer messages are described in provisional application entitled “Multi-Level Media Communications Content and Message Delivery and Response” by Kevin Liao et al., and having Application Ser. No. 61/757,211, and which is incorporated by reference herein in its entirety.

FIG. 2 is a high-level diagram showing aspects of a discrete multimedia content provider-distributor network in the music industry, according to certain embodiments. As described in the example above, in a discrete music industry provider-distributor network, Artists create original content that can be distributed, such as through a network; Venue owners and managers showcase artist work at physical sites; Events market and create interest in live events; Bloggers write artist reviews; and College radio broadcasters provide a distribution network for new artists. FIG. 2 shows as content providers (201, 202, 203, 204, 205) artists 201, venues 202, events 203, bloggers 204 and college radio broadcasters 205. The embodiments are not limited to the content providers shown in FIG. 2. There may be multiple content providers from a given user category (user channel). For example, while only one event 203 is shown, there may be a plurality of events. Similarly, there may be a plurality of venues, bloggers, and college radio broadcasters.

FIG. 2 also shows a server instance 206, and stations (207, 208, 209, 210, 211) such as artist station 207, venue station 208, event station 209, blogger station 210, and college radio broadcaster station 211. Although five (5) channels are shown in FIG. 2, there may be many more stations because the number of stations corresponds to the number of content providers from any of the channel categories mentioned above. Further, it is to be understood that there may be multiple server instances that are associated with one or more servers in the computer-implemented platform of the embodiments. Each station uses server instance 206 to create and manage content streams (215, 217, 219, 221, 223) for streaming to content consumers 250. Stations (207, 208, 209, 210, 211) can also use server instance 206 to perform one or more of the following functions: 1) curate content, 2) search content, 3) create content, 4) promote content, 5) acquire content, 6) distribute content amongst broadcasting stations, 7) discover content, and 8) monetize products and services. Content consumers 250 may provide feedback information 225. Further, stations or content consumers may create customized messages with any content (audio or video or image or graphics or text, either alone or any combination thereof) desired, known as a “shout out” message. The shout out message may then be sent to the server instance for processing and thereby inserted directly into content streams (215, 217, 219, 221, 223) for instantaneous, near-instantaneous, or other time interval communication of the shout out message to one or more stations (i.e., broadcasters) and/or content consumers. Similarly, content consumers and stations can create “shout back” messages, such as messages (216, 218, 220, 222, 224) for sending back in reply to the shout out message. Shout back messages can be customized messages with any content (audio or video or image or graphics or text, either alone or any combination thereof).

FIG. 3 is a high-level drawing that illustrates the interactivity between stations using certain embodiments of the computer-implemented platform. Such interactivity includes interactivity amongst stations as well as interactivity between and among stations and content consumers. Content consumers can also interact with other content consumers. The computer-implemented functions and features described with reference to FIG. 3 are herein referred to as the “locker application.” Some or all of the functions and features of the locker application are optional.

For ease of explanation, FIG. 3 is described herein with reference to the music industry content provider-distributor network described above. However, as previously explained, the computer implemented platform is created to support and enhance networking relationships in any multimedia communications industry involving discrete content provider-distributor networks. FIG. 3 shows content lockers (301, 316) in network 300. Content lockers are used in the curation and distribution of content by stations through a user interface to access the locker application. Each locker is associated with a station as previously described. Stations in network 300, by using content lockers (301, 316), create multimedia content streams (314, 322) that are streamed to content consumers 315. Only two lockers are shown in FIG. 3 for ease of description. It is to be understood that the embodiments are scalable to accommodate a multiplicity of lockers corresponding to a multiplicity of stations. As previously explained according to certain embodiments, there may be numerous 1) artist stations, 2) venue stations, 3) event promoter stations, 4) blogger stations, and 5) college radio broadcaster stations

According to certain embodiments, a given content locker includes but is not limited to a shout-out communication interface (330, 337), locked station content module (331, 338), unlocked station content from “my station” module (332, 339), acquired unlocked content acquired from “other stations” module (333, 340), content data compilation module (334, 341), monetization module (335, 342), and content creation module (336, 343). The modules represent software/hardware/middleware application logic rather than actual modules.

The station holder (station “Administrator”) can upload to the “locked station content” module (331, 338) content to which the station owner owns proprietary rights or has an obligation to preserve someone else's proprietary rights (e.g., royalty-bearing content). For example, the station holder can upload song tracks or music video or other content that the station holder does not want to share with other stations via “side-loading” and does not want others to download such content (e.g., the holder has “locked” such content). However, the station holder can include such content for creating media streams (314, 322) for streaming to content consumers 315. Side-loading involves “pulling” or “pushing” content from or to other stations and is described in greater detail herein with reference to FIG. 4, FIG. 5 and FIG. 6. A given station holder can upload to the “unlocked station content from my station” module (332, 339) content that the station holder owns but would like to share with other stations by “pushing” (305, 309) or “pulling” (306, 310) and with content consumers. For example, the station holder can manipulate the access rights of the song tracks or music video or other content such that these contents can be side-loaded by other stations and/or downloaded by content consumers. Also, the station holder can include such content from the module (332, 339) for creating media streams (314, 322) for streaming to content consumers 315. The station holder can also upload to the “acquired unlocked content from other stations” module (333, 340) content that was “pushed” (307, 350) or “pulled” (308, 351) from other stations. The access rights to such content are such that it can be shared between stations and/or downloaded by content consumers. Also, the station holder can include such content from the module (333, 340) for creating media streams (314, 322) for streaming to content consumers 315.

To further explain by way of example, in certain embodiments, a song track that is authorized for side-loading or downloading in one station can be accessed by content consumers (e.g., listeners) of other stations for both listening and downloading. Further, any station holder and any listener (content consumer) may trace the path of each item of side-loaded content in the network of stations 300 through a user interface described in greater detail with reference to FIG. 4-FIG. 6 herein.

A station or a content consumer (listener) can also create and send shout-outs (302, 317) and send shout-backs (302, 317) to stations by using the communication interface (330, 337). Further, a station holder has the option of sharing the shout-out/shout-back content with other stations by uploading (318, 304) such content to module (333, 340).

Thus, a station holder can create interesting media streams for broadcasting by selectively integrating content from all or a subset of the modules in the locker.

The locker application can also be used to manage a station. For example, a station Q can use the content data compilation module (334, 341) to see statistical information such as but not limited to: 1) the number of stations that have side-loaded content from station Q, 2) how many songs or other content have been downloaded, 3) consumer feedback (360, 361), 4) consumer ratings of the station, 5) consumer interaction, 6) proportion of locked content to unlocked content at the station, 7) consumer ratings of content, 8) donations from consumers or other stations, etc. According to certain embodiments, some of the information from content data compilation module (334, 341) may be used for creating media streams (314, 322) for streaming to content consumers 315. According to certain embodiments, a station can be associated with a “value” or rating based on but not limited to consumer feedback and/or ratings, content and station usage information, and information revealing various other aspects of the station's interactions through the integrated provider-distributor network such as content acquired, promoted, distributed, etc. According to certain embodiments, the higher the “value” of a station, the higher it ranks in search results presented to a user performing a search for content, or for stations from which to pull content, or to which to push content, for example.

According to certain embodiments, the locker application aids in collecting data for each station and assigns a “value” with several practical applications for both in-app and out-of-app activities. For example, a highly valued station can appear in front of listeners on the station's interface more frequently; be featured more prominently to enable other stations to choose which pushed tracks to accept to a station; while also being a target for businesses and other parties looking to do business with the station holder.

The locker application can also be used to monetize products and services. A station can use the monetization module (335, 342) to access monetization opportunities including but not limited to: 1) fee payments, (e.g., subscription fees, content download fees, broadcast fees, station fees, etc.), 2) brand sponsorship access, 3) merchandizing, 4) event ticketing, and 5) other monetization methods.

An example of a commercial use involves the multimedia communications industry. A station can determine which content and at what price the content can be accessed by a consumer. There can be a price per item of content or for a stream of various content. For example, station X can set a price for accessing to a stream of content associated with station X using various options. Options may include but are not limited to: 1) a “name-your-price” access rate, 2) a specified “fixed-price” access rate, and 3) a specified “minimum-price” access rate. Similarly, each song track or content unit that is enabled for download or is created using the “content creation” module (336, 343) described below may be designated by the station for access by a listener (content consumer) on “name-your-price,” “fixed-price,” or “minimum price” terms.

According to certain embodiments, brand sponsorship access can provide monetization opportunities. For example, advertisers may want to target their outreach (e.g., marketing) efforts to reach a calculable number of consumers of specific stations for a specified period of time. In the music industry, the monetization module (335, 342) and other modules can provide a customized and automated platform to allow advertisers (e.g., businesses) to purchase for such consumers, a right to access certain stations for a limited time period. Such access may be referred to as a “pass.”

The “content creation” module (336, 343) enables stations to create original content by allowing “in-app” (using the platform described herein) recordings. This can be done through the client device microphone or any input ports connected to a mixer. This content can be distributed live (321, 313) to content consumers (e.g., followers or fans) or stored (320, 319, 312, 311) in the lockers and can also be monetized, including by using methods such as subscriptions and downloads.

FIG. 4 illustrates sample content consumer interfaces associated with the locker application and the computer-implemented platform, according to certain embodiments.

FIG. 4 shows a home page display 401 of a content consumer that is using the locker application and the computer-implemented platform. Home page display 401 shows active stations in each channel 402. For example, the active stations may be displayed in categories such as but not limited to artists stations 403, venues stations 404, events stations 405, blogs stations 406, and college broadcaster stations 407. A content consumer can use the interface to search and discover stations in each station category. According to certain embodiments, the home page 401 is populated based on but not limited to: 1) the content consumer's geographical location, 2) the content consumer's content consumption history, 3) the content consumer's preference settings, 4) payment for stations to be featured on a prime display location on the content consumer's home page, 5) ratings values of the displayed stations, etc.

According to certain embodiments, the locker application provides an interactive user interface to content consumer to perform searches. To explain in the context of the music industry content provider-distributor network example described above, integrated into the search results is both music and event data. All the categories of stations/channels will produce a search result targeted to each specific search. For example, an artist search may display to the listener the original artist station; followed by artist stations that have “side-loaded” content from the original artist; venues (stations) where the artist is scheduled to perform or has performed; venue stations that have “side-loaded” content from the original artist; events (stations) where the artist is scheduled to perform or has performed; Blogs, and college broadcaster radio stations that have “side-loaded” content from the original artist.

FIG. 4 also shows a sample content trail interface 408. According to certain embodiments, the content consumer (410) can interact with the content trail interface 408 to allow the user to see, as an example, what content is currently streaming (420), including name of the content 421 and the artist 423 associated with the content. The content trail interface 408 can also show the stations (stations A-F, etc.) that have side-loaded the content that is currently streaming. The content consumer may use the interface to discover more stations, if any.

FIG. 5 illustrates sample station holder (e.g., the station Administrator) interfaces associated with the locker application and the computer-implemented platform, according to certain embodiments.

FIG. 5 shows a sample home page 501 for a station. Home page 501 includes a content list display 502. For example, the content list displays the content units (506) for streaming by the station (e.g., song 1-song 6). Each content unit or stream is associated with icons to indicate if the content can be shared/side-loaded (503), and/or can be downloaded (504). The station holder can use the interface to see other stations and associated content available for streaming, if any

FIG. 5 also shows a sample search screen 504. A station holder can use the search screen to search for stations to which content can be pushed (505). For example, the search screen allows searches for artist stations, venue stations, event stations, blog stations, college broadcaster radio stations, etc. The station holder can use the interface to discover more stations, if any.

FIG. 6 illustrates more sample station holder interfaces associated with the locker application and the computer-implemented platform, according to certain embodiments.

FIG. 6 shows a “pushed” content sample display screen 602. According to certain embodiments, when a station pushes a track or other content to a selected station, the pushed track/content is sent to the selected station's pushed content inbox 609. The sample “pushed” content inbox 609 interactive display screen 602 allows a station holder to select and add (604) content to the station's stream. The station holder can also preview (605) pushed content, view if pushed content is available for download by listener (606), if unlocked for download, see the name (607) of the pushed content, and see the value (608) of the pushed content, for example. The station holder can use the interface to see more pushed content, if any.

FIG. 6 also shows a sample search screen 620. A station holder can use search box 621 to search other stations' lockers for content that the station holder would like to pull, according to certain embodiments. Sample search screen 620 displays the search results (625) of a search for desired content (songs 1-5). Also, the station holder can also preview (622) content, see which content can be pulled by other stations (623), and which content can be downloaded by listeners (624). The station holder can use the interface to discover more desired content, if any.

FIG. 7 illustrates a home screen graphical user interface, according to certain embodiments. In the Listener Home screen 700, users can access the listener home screen to view stations categorized by Artists 702, Venues 704, Events 706, Blogs (not shown in the figure), and College Radio stations (not shown in the figure), etc. The stations are listed using the invention's (e.g., “Avenue Live's”) proprietary technology, which incorporates location, popularity of the station and listening preferences of the user.

FIG. 8 illustrates a listener search screen graphical user interface, according to certain embodiments. In Listener Search screen 800, a listener sees this screen when tapping on the search icon 802. A station holder can access this screen as well. Users can search for specific stations, or artists, tracks, or tags that were used when labeling specific tracks.

FIG. 9 illustrates a “now playing” screen graphical user interface, according to certain embodiments. In the Now Playing Screen 900, functions include stop 902, play, skip to next station 904 or previous station 906 (this depends on where the station was accessed: if from “My Stations” mode, the next station will be from “My Stations” list; if from “Discover” mode, the next station will be chosen based on the listener's “listening profile”; if from “Home” screen, the next station will be based on a custom Avenue Live technique that includes location, type, popularity, etc.), subscribe 908 (heart icon), like 910 (thumbs up icon), download 912 (down-arrow icon—download is available by tapping the album artwork), and track footprint (displays all the stations that have the track sideloaded, including the originating station. See FIG. 15 in this document. If listener taps anywhere on album graphics (except footprint), then the listener is taken to a “more options/marketplace” screen. See FIG. 10 in this document or “more options/market place” screen.

FIG. 10 illustrates an options and listener marketplace screen graphical user interface, according to certain embodiments. In the More Options/Listener Marketplace screen 1000 (Tap album art to view), when a user taps on the album artwork he or she will see options that were customized by the station owner. The user can download 1002 the currently playing track (if it was enabled by the station owner); purchase 1004 the track through a third party store (e.g., iTunes or Amazon); Sideload 1006 the track (if made available by the station owner—this option is only available to other station owners); share 1008 the track through social media, etc.; access more station options through “About Station” 1110; send 1112 a shout out to the station; view 1014 a list of events for the given station holder and have the option to purchase tickets; access an outside Merchandise link 1016 (if any); visit the station owner's primary Website 1018; Subscribe 1020 to the station and report 1022 any issues to Avenue Live.

FIG. 11 illustrates a listener menu options screen graphical user interface, according to certain embodiments. In the Listener Menu Options screen 1100, a slide out menu displays features accessible by listeners. From this screen, listeners can access the Home screen 1102, Discover feature 1104, Search screen 1106, Subscriptions 1108 (stations the listener has subscribed to), Coming Events 1110 (location-based event discovery), and an inbox of Shout Outs 1112 (from Stations).

FIG. 12 illustrates a station tracks list screen graphical user interface, according to certain embodiments. In the Station Tracks List screen 1200 Station's tracks 1202 can be accessed through the “About Station” view. Station's tracks 1202 displays a list of tracks 1204. Users, including listeners, can access this feature. Listeners can use this view to preview tracks and if “enabled for download”, can download the tracks. Other station holders can access this view to preview tracks and if “enabled for sideload,” can sideload the tracks into their stream.

FIG. 13 illustrates a station events list screen graphical user interface, according to certain embodiments. In the Station Events List screen 1300, Station's Events 1302 can be accessed through the “About Station.” view as well Users can see a list of events 1304 that were either created by station holders or obtained by Avenue Live through a third party. If available, users can purchase tickets to the events.

FIG. 14 illustrates a discover mode screen graphical user interface, according to certain embodiments. The Discover Mode screen 1400 populates a chain of stations 1402 based on user listening preferences. Tags of each track liked and tags of each track in a station are accumulated to create a listener profile. Stations are recommended based on Avenue Live's proprietary technology to recommend stations to fit a listener profile. Discover mode can be local 1404, or app-wide 1406.

FIG. 15 illustrates a track footprint screen graphical user interface, according to certain embodiments. In the Track Footprint screen 1500, when a listener taps the footprint icon, the screen below displays other stations 1502 that have sideloaded the currently playing track as well as the originating station. (The larger image 1504 indicates the station where a specific track originated.) The listener can then click on other stations to discover music from those stations.

FIG. 16 illustrates a coming events screen graphical user interface, according to certain embodiments. The Coming Events screen 1600 provides users the ability to see upcoming events 1602 based on geographical location and date. Events are listed by channel and by distance to user viewing “Coming Events”. Users enter city 1604 and date 1606 to view events. They can then click into a station to preview it's content (music, etc).

FIG. 17 illustrates a station holder profile setup screen graphical user interface, according to certain embodiments. In the Station Holder Profile setup screen 1700 (“About Station” “Info” tab), a station holder can edit station info 1702 and subscription rate 1704 and include a custom message that listeners see when subscribing to the station. “Support Message” 1706 is a message that the station holder can specify and which will be automatically sent to a listener when the listener hits the “heart” subscribe icon.

FIG. 18 illustrates a station holder admin screen graphical user interface, according to certain embodiments. The Station Holder Admin screen 1800 displays audio content playing in a station holder's stream. The audio content comprises tracks 1802 uploaded by the station owner, tracks sideloaded from other stations, shout out messages from the station owner, shout out messages from other stations, shouts out from fans and live broadcasts. The station owner can organize the audio content here and access individual track controls of each piece of content.

FIG. 19 illustrates a track controls screen graphical user interface, according to certain embodiments. The Track Controls screen 1900 shows that when user selects a track (using screen of FIG. 18, for example) that was originally uploaded by the station owner, the screen opens up a control menu that allows a station holder to determine whether or not a track is Sideloadable 1902, downloadable 1904, and station holder can set a price 1906 on the download, send 1910 the track to another station holder, and/or rearrange the order 1908 of the track in the station stream. The “Send To” feature 1910 allows a Station Holder to “Push” the track to another station holder's station. The “Popularity” indicator displays the relative popularity of the track determined by Avenue Live's custom technology. From this screen the station owner can tag each track (important for discovery by listeners and station owners).

FIG. 20 illustrates a station subscription screen graphical user interface, according to certain embodiments. In the Station Subscription screen 2000, a listener sees when subscribing to a station. The listener is prompted to pay a minimum (if any) and can always name a “Custom Subscription” above the specified rate. In the example below, the station rate was set as Free and the listener creates a “Custom Subscription” 2002 of $1/month (which is $1 more than the minimum “Free” rate set by the station owner).

FIG. 21 illustrates a shout out inbox screen graphical user interface, according to certain embodiments. In the Shout Out Inbox screen 2100, Station Holder can view shout outs sent to his/her station here. For example, a station holder can receive shout outs 2102 from listeners, artists, and other stations. The station holder can respond to the shout outs directly or place them into his or her stream.

FIG. 22 illustrates a tracks received inbox screen graphical user interface, according to certain embodiments. In the Tracks Received Inbox screen 2200, Station holder can view all tracks sent 2202 to his/her station here. For example, a venue might get tracks sent to that venue from an artist. The venue can then preview the tracks, an attached shout-out (if any) and choose if she wants to include either the tracks or attached shout-out in her stream for broadcasting. The tracks in the inbox can be sorted by different methods including “popularity” as defined by the Avenue Live technology.

FIG. 23 illustrates a station links list screen graphical user interface, according to certain embodiments. In the Station Links List screen 2300, Station Holder links 2302 can be accessed through the “About Station” view. The station holder determines which links exist here 2304. Some of the links can also be accessed more directly by tapping on the album artwork of the “Now Playing Screen”.

FIG. 24 illustrates a shout out screen graphical user interface, according to certain embodiments. In the Shout Out screen 2400, Station Holders can access the shout out screen under different modes. The shout out is used when sending direct messages to other station holders or, to fans, adding audio messages to the stream, or when coupling a pushed track with an audio message. From here, station holders can choose to “Broadcast Live” 2402, which means to interrupt the stream and stream live to the station's fans. Listeners also have access to this screen when sending shout outs to stations but do not have access to the “Broadcast Live” feature 2402.

FIG. 25 illustrates a shout out recording screen graphical user interface, according to certain embodiments. This shout out recording screen 2500 displays a shout out recording in progress.

FIG. 26 illustrates a broadcast live screen graphical user interface, according to certain embodiments. The Broadcast Live screen 2600, allows users to stream directly to their listeners through their device via the device mic or alternative device input. The stream is also saved in the playlist with same control options as any other track, which include enabling sideload, download, and custom monetization.

FIG. 27 illustrates an analytics screen graphical user interface, according to certain embodiments. In the Analytics screen 2700, a station holder can see data and analytics 2702 in the app that include revenue generated by the station, listener and other station-based behavior and analytics. The screen also shows subscribers information 2704.

FIG. 28 illustrates a continuation of the analytics screen of FIG. 27, according to certain embodiments. Screen 2800 is a continuation of Analytics screen 2700 and shows station popularity information 2802. top cities information 2804. and downloads information 2806.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

We claim:

1. A graphical user interface comprising:
a track footprint display for displaying stations that have sideloaded a currently playing track; and
a shout out inbox display for displaying shout out received from one or more listeners.

2. The graphical user interface of claim 1, further comprises a station links display for displaying one or more links to other content or websites.

3. The graphical user interface of claim 1, further comprises a station events display for displaying one or more events.

4. The graphical user interface of claim 1, further comprises a broadcast live display for allowing a user to stream directly to listeners.

5. The graphical user interface of claim 1, further comprises a recording in progress display.

6. The graphical user interface of claim 1, further comprises an analytic data display for displaying analytics data that is associated with a station.

7. The graphical user interface of claim 1, further comprises an discover mode display for populating a chain of stations based on a user's preferences.

8. The graphical user interface of claim 1, further comprises a market place options display for allowing a user to purchase content or merchandize.
